(19) United States
(12) Patent Application Publication
(10) Pub. No.: US 2022/0049114 A1
(43) Pub. Date: Feb. 17, 2022

(54) FIRE RETARDANT THERMALLY INSULATING LAMINATE

(71) Applicants: Dow Global Technologies LLC, Midland, MI (US); Rohm and Haas Company, Collegeville, PA (US)

(72) Inventors: Charles J. Rand, Philadelphia, PA (US); Gregory T. Stewart, Midland, MI (US); Matthew J. Kalinowski, Freeland, MI (US); Xiangyang Tai, Shanghai (CN); Larry W. Mobley, Canton, GA (US)

(21) Appl. No.: 17/296,637

(22) PCT Filed: Feb. 11, 2019
(86) PCT No.: PCT/CN2019/074786

§ 371 Date: May 25, 2021

(51) Int. Cl. C09D 5/18; C09D 175/08; C08G 18/76; C08G 18/48; C08G 18/36; C08G 18/66; B32B 5/02; B32B 21/10

(52) U.S. Cl. CPC C09D 5/185; C09D 175/08; C08G 18/7671; C08G 18/4829; C08G 18/36; C08G 18/6696; B32B 2307/3065; B32B 21/10; B32B 2250/02; B32B 2260/021; B32B 2260/046; B32B 2262/101; B32B 5/022

(57) ABSTRACT

The present disclosure relates to a fire retardant laminate and a fire-resistant wood product comprising the fire retardant laminate.

### FIELD OF THE INVENTION

The present disclosure relates to a fire retardant laminate and a fire-resistant wood or other building product comprising the fire retardant laminate.

### INTRODUCTION

In some applications, there is a need for a low profile in-situ insulation for materials exposed to fires or extreme temperatures. I-joist is one of these applications. Engineered wood I-Joists are quickly replacing lumber in new homes in order to accommodate trends in home design. In fire testing, these joists perform significantly worse than lumber as the binder quickly deteriorates and the joists lose mechanical integrity. The AC14 testing criteria, which includes ASTM E119, is now being used to ensure engineered wood products perform similar to lumber in new constructions. The E119 involves loading a floor made from at least one joist loaded to 50% of its full allowable stress design bending design load. The joist(s) are then subject to a temperature ramp of a chamber that is heated to almost 800° C., and if the floor supports the load and does not fail the specified deflection and deflection rate criteria, for 15 minutes and 31 seconds or longer, it is deemed as having equivalency to dimension lumber. An engineered wood I-joist without thermal protection will perform very poorly in this test, failing much quicker than dimension lumber. There are many ways of addressing this performance gap including finishing with drywall, which then limits the potential application of engineered I-joists to finished basements in new constructions. For unfinished basements, intumescent coatings, fire resistant polyisocyanurate foams, sprinkler systems, fiberglass reinforced magnesium oxide coatings, mineral wool insulation, and ceramic sheathing with intumescent paper are used.

Therefore, there is still a need for a fire retardant laminate which can be factory or field applied and is thinner than foams and wool insulation, making distribution easier. We have developed a fire retardant laminate with a fire retardant coating on an inorganic fiber, which reduces the amount of coating needed and allows for the ability to field apply the protection, ensuring uniform performance. In addition, we have found a way to include an impermeable substrate that is not capable of supporting vertically mounted char structures independently. This laminate also offers the benefit of being repaired easily in the field.

### SUMMARY OF THE INVENTION

The present disclosure provides a fire retardant laminate and a fire-resistant wood product comprising the fire retardant laminate, wherein the fire retardant laminate exhibits a good fire retarding property, a good thermal insulation performance and/or good weatherability.

In a first aspect, the present disclosure provides a fire retardant laminate comprising an inorganic fiber; and a fire retardant coating applied on the inorganic fiber, wherein the fire retardant coating comprises an aromatic isocyanate component, a polyol component and an intumescent component.

In a second aspect, the present disclosure provides a fire-resistant wood product comprising:

a wood element having one or more surfaces; and

a fire retardant laminate applied to at least a portion of the one or more surfaces, wherein the fire retardant laminate comprises an inorganic fiber and an fire retardant coating applied on the inorganic fiber, wherein the fire retardant coating comprises an aromatic isocyanate component, a polyol component and an intumescent component.

In a third aspect, the present disclosure provides a fire-resistant building product comprising:

a cellulose-based (wood, paper), gypsum, (bio)polymeric, or cementitious element having one or more surfaces, wherein the fire retardant or sound resistant laminate comprises an inorganic fiber and an fire retardant coating applied on the inorganic fiber, wherein the fire retardant coating comprises an aromatic isocyanate component, a polyol component and an intumescent component.

In a fourth aspect, the present disclosure provides a sound resistant building product comprising:

a cellulose-based (wood, paper), gypsum, (bio)polymeric, or cementitious element having one or more surfaces, wherein the fire retardant or sound resistant laminate comprises an inorganic fiber and an fire retardant coating applied on the inorganic fiber, wherein the fire retardant coating comprises an aromatic isocyanate component, a polyol component and an intumescent component.

### DETAILED DESCRIPTION OF THE INVENTION

As disclosed herein, “and/or” means “and, or as an alternative”. All ranges include endpoints unless otherwise indicated.

As disclosed herein, the terms “composition”, “formulation” or “mixture” refer to a physical blend of different components, which is obtained by simply mixing different components by physical means.

“Wood product” is used to refer to a product manufactured from logs such as lumber (e.g., boards, dimension lumber, solid sawn lumber, joists, headers, trusses, beams, timbers, mouldings, laminated, finger jointed, or semi-finished lumber), composite wood products, or components of any of the aforementioned examples. The term “wood element” is used to refer to any type of wood product.

“Composite wood product” is used to refer to a range of derivative wood products which are manufactured by binding together the strands, particles, fibers, or veneers of wood, together with adhesives, to form composite materials. Examples of composite wood products include but are not limited to parallel strand lumber (PSL), oriented strand board (OSB), oriented strand lumber (OSL), laminated veneer lumber (LVL), laminated strand lumber (LSL), particleboard, medium density fiberboard (MDF) and hardboard.

“Intumescent particles” refer to materials that expand in volume and char when they are exposed to fire.

The word “coating” and “formulation” can be substituted with each other and they have the same meaning for the purpose of this invention.

The word “weatherability” is used to describe the ability of the material to withstand exterior exposure as would be necessary for factory application and is described in section A4.4.5 of the AC14: Acceptance Criteria for prefabricated wood I-Joists. Weatherability refers to a materials ability to retain fire performance after exposure to ultraviolet light and water and also soaked in water and then frozen as described in the AC14 test method or the methods used here for small scale testing.

The Aromatic Isocyanate Component

The aromatic isocyanate component may be present in a quantity ranging from about 10% to about 30% by weight of the coating, preferably about 15% to about 25% by weight of the coating.

The aromatic isocyanate may be a single aromatic isocyanate or mixtures of such compounds. Examples of the aromatic multifunctional isocyanates include toluene diisocyanate (TDI), monomeric methylene diphenyldiisocyanate (MDI), polymeric methylenediphenyldiisocyanate (pMDI), 1,5′-naphthalenediisocyante, and prepolymers of the TDI or pMDI, which are typically made by reaction of the pMDI or TDI with less than stoichiometric amounts of multifunctional polyols.

The Polyol Component

The polyol component can be naturally derived polyol, polyether polyol, polyester polyol, a combination thereof and the like.

The naturally derived polyol is naturally occurring, can be vegetable oil polyol or a polyol derived from vegetable oil. The naturally derived polyol has ester linkages and can be a castor oil or hydroxylated soybean oil, or a combination thereof and the like.

Castor oil is a mixture of triglyceride compounds obtained from pressing castor seed. About 85 to about 95% of the side chains in the triglyceride compounds are ricinoleic acid and about 2 to 6% are oleic acid and about 1 to 5% are linoleic acid. Other side chains that are commonly present at levels of about 1% or less include linolenic acid, stearic acid, palmitic acid, and dihydroxystearic acid.

Polyether polyols can be the addition polymerization products and the graft products of ethylene oxide, propylene oxide, tetrahydrofuran, and butylene oxide, the condensation products of polyhydric alcohols, and any combinations thereof. Suitable examples of the polyether polyols include, but are not limited to, polypropylene glycol (PPG), polyethylene glycol (PEG), polybutylene glycol, polytetramethylene ether glycol (PTMEG), and any combinations thereof. In some embodiments, the polyether polyols are the combinations of PEG and at least one another polyether polyol selected from the above described addition polymerization and graft products, and the condensation products. In some embodiments, the polyether polyols are the combinations of PEG and at least one of PPG, polybutylene glycol, and PTMEG.

Polyether polyol can be an aromatic polyether polyol, for example, an aromatic resin-initiated propylene oxide-ethylene oxide polyol, such as IP 585 polyol available from the Dow Chemical Company.

The polyester polyols are the condensation products or their derivatives of diols, and dicarboxylic acids and their derivatives. Suitable examples of the diols include, but are not limited to, ethylene glycol, butylene glycol, diethylene glycol, triethylene glycol, polyalkylene glycols such as polyethylene glycol, 1,2-propanediol, 1,3-propanediol, 2-methyl-1,3-propandiol, 1,3-butanediol, 1,4-butanediol, 1,6-hexanediol, neopentyl glycol, 3-methyl-1,5-pentandiol, and any combinations thereof. In order to achieve a polyol functionality of greater than 2, triols and/or tetraols may also be used. Suitable examples of such triols include, but are not limited to, trimethylolpropane and glycerol. Suitable examples of such tetraols include, but are not limited to, erythritol and pentaerythritol. Dicarboxylic acids are selected from aromatic acids, aliphatic acids, and the combination thereof. Suitable examples of the aromatic acids include, but are not limited to, phthalic acid, isophthalic acid, and terephthalic acid; while suitable examples of the aliphatic acids include, but are not limited to, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid, and 2,2-dimethyl succinic acid. Anhydrides of these acids can likewise be used. For the purposes of the present disclosure, the anhydrides are accordingly encompassed by the expression of term “acid”. In some embodiments, the aliphatic acids and aromatic acids are saturated, and are respectively adipic acid and isophthalic acid. Monocarboxylic acids, such as benzoic acid and hexane carboxylic acid, should be minimized or excluded.

Polyester polyols can also be prepared by addition polymerization of lactone with diols, triols and/or tetraols. Suitable examples of lactone include, but are not limited to, caprolactone, butyrolactone and valerolactone. Suitable examples of the diols include, but are not limited to, ethylene glycol, butylene glycol, diethylene glycol, triethylene glycol, polyalkylene glycols such as polyethylene glycol, 1,2-propanediol, 1,3-propanediol, 2-methyl 1,3-propandiol, 1,3-butanediol, 1,4-butanediol, 1,6-hexanediol, neopentyl glycol, 3-methyl 1,5-pentandiol and any combinations thereof. Suitable examples of triols include, but are not limited to, trimethylolpropane and glycerol. Suitable examples of tetraols include erythritol and pentaerythritol.

The polyol component may be present in a quantity ranging from about 20% to about 60% by weight of the coating. In a preferred embodiment, the polyol component may be present in a quantity ranging from about 30% to about 50%.

In some embodiment, the polyol component comprises castor oil and an aromatic polyol, such as IP585 (an aromatic polyether polyol from the Dow Chemical Company) or IP-9004 (an aromatic polyester polyol from the Dow Chemical Company).

The amount of the castor oil in the polyol component is, by weight based on the weight of the polyol component, at least 50 wt %, or at least 60 wt %, or at least 70 wt %. The amount of the castor oil in the polyol component is not to exceed, by weight based on the weight of the polyol component, 99 wt %, or 97 wt %, or 95 wt %.

The amount of the aromatic polyol in the polyol component is, by weight based on the weight of the polyol component, at least 5 wt %, or at least 10 wt %, or at least 15 wt %. The amount of the aromatic polyol in the polyol component is not to exceed, by weight based on the weight of the polyol component, 50 wt %, or 40 wt %, or 30 wt %.

Intumescent Component

As described above, fire-resistant coatings according to embodiments of the disclosure also include an intumescent component.

The intumescent component may be present in a quantity ranging from about 1% to about 40% by weight of the total coating. In a preferred embodiment, the intumescent component is present in a quantity ranging from about 10% to about 30% by weight of the coating. The intumescent component may be intumescent particles.

Intumescent particles suitable for use with embodiments of the disclosure include expandable graphite, which is graphite that has been loaded with an acidic expansion agent (generally referred to as an “intercalant”) between the parallel planes of carbon that constitute the graphite structure. When the treated graphite is heated to a critical temperature, the intercalant decomposes into gaseous products and causes the graphite to undergo substantial volumetric expansion. Manufacturers of expandable graphite include GrafTech International Holding Incorporated (Parma, Ohio). Specific expandable graphite products from GrafTech include those known as Grafguard 160-50, Grafguard 220-50 and Grafguard 160-80. Other manufacturers of expandable graphite include HP Materials Solutions, Incorporated (Woodland Hills, Calif.). There are multiple manufacturers of expandable graphite in China and these products are distributed within North America by companies that include Asbury Carbons (Sunbury, Pa.) and the Global Minerals Corporation (Bethseda, Md.). Further, other types of intumescent particles known to a person of ordinary skill in the art would be suitable for use with embodiments of the disclosure. Preferably, the intumescent and FR components are insoluble in water.

Additive Components

In addition to the aromatic isocyanate, the polyol component and the intumescent component, the fire-resistant coatings according to embodiments of the disclosure may include one or more additive components.

The additive component may be present in a quantity ranging from about 0% to about 30% by weight of the coating, preferably about 10% to about 20% by weight of the coating.

Additives that may be incorporated into the fire retardant coating formulation to achieve beneficial effects include but are not limited to surfactants, wetting agents, opacifying agents, colorants, viscosifying agents, catalysts, preservatives, fillers, leveling agents, defoaming agents, diluents, hydrated compounds, halogenated compounds, moisture scavenger (for example molecular sieves, aldimines or p-toluenesulfonyl isocyanate), acids, bases, salts, borates, melamine and other additives that might promote the production, storage, processing, application, function, cost and/or appearance of this fire retardant coating for wood products.

Additional flame-retardant components may be added to the coating to enhance the flame-retardant properties of the coating. For example, a halogenated flame retardant may be added to reduce flame spread and smoke production when the coating is exposed to fire. Halogenated flame retardants prevent oxygen from reacting with combustible gasses that evolve from the heated substrate, and react with free radicals to slow free radical combustion processes. Examples of suitable halogenated flame-retardant compounds include chlorinated paraffin, decabromodipheyloxide, available from the Albermarle Corporation under the trade name SAYTEX 102E, and ethylene bis-tetrabromophthalimide, also available from the Albermarle Corporation under the trade name SAYTEX BT-93. The halogenated flame-retardant compound is typically added to the coating in a quantity of 0-5% of the coating by weight, although greater amounts may also be used. Often, it is desirable to use the halogenated flame-retardant compound in combination with a synergist that increases the overall flame-retardant properties of the halogenated compound. Suitable synergists include zinc hydroxy stannate and antimony trioxide. Typically, these synergists are added to the coating in a quantity of 1 part per 2-3 parts halogenated flame retardant by weight, though more or less may also be used. In addition, other organophosphorus flame retardants, such as resorcinol bis(diphenylphosphate) (RDP) and bisphenol A bis(diphenylphosphate) (BPA-BDPP) can also be added to the coating to enhance the flame-retardant properties of the coating.

Preferably, the FR additives are insoluble in water.

Inorganic Fiber

The inorganic fiber can be glass fiber, ceramic fiber, rock wool, carbon fiber, alumina fiber, wollastonite and potassium titanate fiber and the like.

Preferably, the inorganic fiber is in the form of an inorganic fiber mat. In an inorganic fiber mat, fibers are bound with an adhesive.

Preferably, the glass fiber is a glass fiber mat, which can be a clay coated glass fiber mat, a glass fiber mat adhered to an aluminum foil, or a clay coated glass fiber mat adhered to an aluminum foil.

The thickness of the glass fiber mat ranges from 3 to 20 micrometers and has a basis weight of typically 5-50 lb/1000 ft².

Preparation of Coating

The components described above may be combined using a number of different techniques. In some embodiments, intumescent particles are dispersed in the polyol along with other additives to form a relatively stable suspension, which can be shipped and stored for a period of time until it is ready to be used. Such a mixture can be referred to in this disclosure as the “polyol component.” The aromatic isocyanate component (e.g., aromatic isocyanate or mixture of aromatic isocyanates) is generally stable and can be shipped and stored for prolonged periods of time as long as it is protected from water and other nucleophilic compounds. Such a mixture can be referred to in this disclosure as the “aromatic isocyanate component”. Prior to application, these two components may be mixed together at a ratio that is generally about 10 to about 30% aromatic isocyanate component and 20 to about 60% polyol component, preferably, with the polyol component containing castor oil. This particular formulating strategy results in a polyurthethane matrix with a suitable level of elasticity for use as a fire-resistant coating. Further, in some embodiments, other advantages may be realized. For example, the prepolymers of TDI or pMDI can have beneficial effects on the elasticity of the polymer matrix and they can alter the surface tension of uncured liquid components so that the intumescent particles tend to remain more uniformly suspended when the polyol and isocyanate components are combined just prior to application.

Prior to application of the coating to the substrate, mixing of the reactive components, especially the polyol and the aromatic isocyanate compounds, should be performed. In one embodiment the intumescent particles can be suspended in polyol along with the other formulation additives to make a stable liquid suspension, which can later be combined with the aromatic isocyanate compounds. Accordingly, the two liquid components can be combined at the proper ratio and mixed by use of meter-mixing equipment, such as that commercially available from The Willamette Valley Company (Eugene, Oreg.) or GRACO Incorporated (Minneapolis, Minn.) or ESCO (edge sweets company). In some embodiments, three or more components (naturally derived polyol, aromatic polyol, intumescent, and aromatic isocyanates) can all be combined using powder/liquid mixing technology just prior to application. In some embodiments, the formulation has a limited “pot-life” and should be applied shortly after preparation. Thereafter, the formulation subsequently cures to form a protective coating that exhibits performance attributes as a fire-resistant coating for wood products.

In the absence of a catalyst, the complete formulation may be applied to the inorganic fiber in less than about 30 minutes after preparation. It is possible to increase the mixed pot-life by decreasing the temperature of the formulation mixture or by use of diluents or stabilizers such as Phosphoric acid. When catalysts are used in the formulation, the mixed pot-life can be less than about 30 minutes. Examples of catalysts include organometallic compounds, such as dibutyltin dilaurate, stannous octoate, dibutyltin mercaptide, lead octoate, potassium acetate/octoate, and ferric acetylacetonate; and tertiary amine catalysts, such as N,N-dimethylethanolamine, N,N-dimethylcyclohexylamine, 1,4-diazobicyclo[2.2.2]octane, 1-(bis(3-dimethylaminopropyl)amino-2-propanol, N,N-diethylpiperazine, DABCO TMR-7, and TMR-2.

Application of Coating

Coatings according to embodiments of the disclosure may be applied to an inorganic fiber, such as a clay coated glass fiber. Generally, coatings according to embodiments of the disclosure are applied to one or more surfaces of a wood product at an application level of about 0.05 to about 3.0 lb/ft², preferably about 0.1 to about 2.0 lb/ft², preferably about 0.1 to about 0.5 lb/ft². In some embodiments, fire-resistant coatings may be applied to a portion of one or more surfaces of the inorganic fiber. In other embodiments, entire surfaces or the entire surface of inorganic fiber may be covered. In some embodiments, the fire-resistant coating covers approximately 50% to approximately 100% of the product's surface area. The coating of the present invention may be applied in a variety of manners, such as spraying, knife over roll coating, or draw down using a Gardco Casting Knife Film Applicator.

### Examples

Some embodiments of the invention will now be described in the following Examples, wherein all parts and percentages are by weight unless otherwise specified.

I. Raw Materials

| Substrate | Supplier |
|---|---|
| Clay Coated Glass | Atlas Roofing's WEBTECH ® Coated Glass Facers |
| Fiber Mat (CCGF) | |
| Aluminum Foil | Lamtec corporation's FG MAT/.0015 |
| Glass Mat | |
| Aluminum Foil | Gordon Food Service - Heavy duty foodservice foil |
| Fiberglass Mat | Atlas Roofing's WEBTECH ® HP 1000 |
| AL/CCGF | Gordon Food Service - Heavy duty foodservice foil |
| | and Atlas Roofing's WEBTECH ® Coated Glass |
| | Facers |
| OSB | Louisiana Pacific Corporation |
| I-Joist | Boise-Cascade |

E119 Testing

The following formulation was prepared and a coating or a coated laminate was applied to I-Joists. The joist were then subjected to an unloaded E119 (Table 2) or a loaded E119 (Table 3). The formulation was prepared as follows: all components except the pMDI were mixed thoroughly. pMDI was then added to the mixture and then applied to the I-Joists or substrate. In the case of the coating directly onto the webstock, a known weight of material was added directly to the joist and then smoothed out to get an even coating. In the case of the coating onto the inorganic fiber substrate, the mixture was applied to the inorganic fiber substrate and a Gardco Casting Knife Film Applicator was used to ensure a uniform application. A known size of coated inorganic fiber substrate was then compared to a known size of inorganic fiber substrate to calculate the application rate. After curing, the laminates were applied to I-Joists with staples at the intersection of the flange and webstock. A floor was then built out of two 14 foot joist and tested by the ASTM E119 portion of AC-14.

TABLE 1
FR1 formulation

| Material | Weight (g) |
|---|---|
| Papi 27 (PolyMDI Isocyanate, DOW) | 18 |
| IP585 (aromatic polyether polyol, DOW) | 7 |
| Castor Oil (Sigma Aldrich) | 35 |
| Resorcinol bis (diphenyl phosphate) (Fyroflex RDP by ICL) | 13 |
| EG (Graftech 160-50-N except where noted) | 27 |
| Surfactant DC-193 (Dow Performance Silicones) | 0.15 |
| Phosphoric Acid | 0.2 |
| DABCO TMR-7 (Evonik) (PU catalyst) | 0.22 |

TABLE 2
Unloaded ASTM-E119 Data

| | Time to | Time to | Temp (° C.) | Remaining |
|---|---|---|---|---|
| Description | 200° C. (mins) | 300° C. (mins) | at 15:31 | Webstock |
| A. FR1 Coating at 0.25 | 2.84, 2.69 | 10.97, 11.59 | 453.66, 479.83 | 5% |
| lb/ft² (comparative) | | | | |
| B. Laminate (CCGF), FR1 | 8.21, 8.96 | 14.04, 13.81 | 334.51, 342.30 | 70% |
| at 0.25 lb/ft² (inventive) | | | | |
| C. Laminate (AL/CCGF), | 9.68, 7.8 | 14.08, 12.18 | 343.97, 408.71 | 95% |
| FR1 at 0.25 lb/ft² (inventive) | | | | |
| D. FR1 Coating at 0.35 | 3.35, 2.75 | 12.5, 15.04 | 426.01, 302.65 | 35% |
| lb/ft² (comparative) | | | | |
| E. Laminate (CCGF), FR1 | 7.41, 11.46 | 14.74, NA | 318.46, 262.30 | 100% |
| at 0.25 lb/ft² (inventive) | | | | |
| F. Laminate (AL) FR1 at | 2.48, 2.26 | 2.93, 6.91 | 800.46, 858.27 | 3% |
| 0.35 lb/ft² (comparative) | | | | |

TABLE 3
Loaded ASTM-E119, average of 8 thermocouples. Time to collapse in
mins:seconds

| | Time to | Time to | Temp | |
|---|---|---|---|---|
| | 200° C. | 300° C. | (° C.) | Time to |
| Description | (mins) | (mins) | at 15:31 | collapse |
| G. Laminate (CCGF) | 9.24 | 13.17 | 479.25 | 15:39 |
| FR1 at 0.27 lb/ft² | | | | |
| H. Coating of FR1 at | 2.42 | 10.68 | NA | 12:38 |
| 0.4 lb/ft² | | | | |

The above data shows that the coated glass mat helps enhance the thermal insulation of the fire retardant coating when applied at the same rate as seen by the remaining webstock results in Table 2. The addition of aluminum foil to the clay coated glass mat further enhances this performance. Example F shows that foil alone is not sufficient to support the char in a vertical loading, as during the intumescent process the char fell off of the aluminum foil, the repercussion of this failure is seen in the rapid rise in temperature and removal of webstock. This is further demonstrated in the loaded ASTM E119 tests shown in Table 3, where the same coating is applied to the coated glass mat at a lower application rate, yet performs significantly better and passes the collapse time portion of the test which is 15:31 for the ASTM E119 portion of the AC-14.

Cone Calorimeter Test

For samples coated directly onto OSB, the mixture as described above (FR1) was applied directly to a 6 inch by 6 inch piece of 7/16 thick OSB from Louisiana Pacific Corporation. For the various substrates, the coating was applied to the substrate at a specific application rate and a 6 inch by 6 inch square was cut out of the cured laminate. The fire resistant laminate specimen was placed onto a 6″×6″ 7/16″ thick OSB square with the coating facing away from the OSB surface. Aluminum foil was then wrapped around the coated OSB, leaving a 4 inch by 4 inch square window free from aluminum foil centered in the middle of the sample so that the coating is visible.

The wrapped sample was placed into a 6 inch by 6 inch stainless specimen sample frame with a corresponding 4 inch by 4 inch opening so that only the coating is visible from the top of the frame. A thermocouple was placed on the backside of the OSB and approximately centered in the 6 inch by 6 inch square. A stainless steel backer frame with mineral wool was applied to the back of the OSB to hold the sample against the inside of the top portion of the frame. The two sides of the frame were affixed together to hold the sample tightly in place.

The aforementioned assembly was placed into a standard cone calorimeter instrument designed to run the ASTM E 1354 test method. The calorimeter was set to heat the specimen at 50 kW and the surface of the sample was mounted 2 inches below the heating element. Thermocouple readings were recorded during the test. The time, in minutes, for the thermocouple reading to rise from 50° C. to 250° C. was recorded for all samples and is shown in Table 4.

TABLE 4
Cone Calorimeter data: Time in minutes to 250° C. as measured from
the back of the OSB

| Coating | | | | Aluminum |
|---|---|---|---|---|
| Amount | No | Clay Coated | Fiberglass | Foil-Glass |
| (lb/ft²) | Substrate | Glass Mat | Mat | Mat |
| none | 4.6 | | | |
| 0.15 | 14.8 | 14.0 | | 19.8 |
| 0.25 | 19.6 | 21.6 | 18.7 | 29.9 |
| 0.35 | 19.3 | 25.5 | | 29.9 |

The table above shows again the incorporation of a coated glass mat substrate provided better insulation compared to just the coating over a range of application rates. When the fiberglass mat is porous, as in the case of the fiberglass mat shown in Table 4, the coating seeps through the mat, filters out the expandable graphite and ruins the performance, making it worse than a coating alone. Having a glass mat adhered to aluminum foil keeps the coating at the surface and further enhances the performances when compared to an equivalent applied coating or the coating applied to a coated glass mat. The foil thus eliminates the issue with porosity of traditional non-woven glass mats. The combination of coated glass mats/uncoated glass mats with aluminum foil thus provides superior thermal insulation performance.

Weatherability Testing

The ingredients listed in Table 1 were dispersed with cowles blade 1000 for 1 min, and then coated on FG MAT/0.0015 at an application rate 1 mm. The laminate was then heated at 80° C. for 3 hours to dry, and conditioned for 48 hours at room temperature. 9 10 cm×10 cm specimens were prepared all at an application rate of 1 mm of coating and applied to a 10 cm×10 cm OSB board. Three were unexposed, three subjected to a UV-water test, and three subjected to a freeze-thaw test. All are 1 mm thickness on 10 cm×10 cm OSB board.

UV-Water Test

An Osram Ultra-Vitalux 300 W lamp was placed 72 cm from the samples. The samples were exposed for 4 hours, followed by 4 hours of water immersion. This was then repeated for 7 cycles. The samples were then dried at 100° C. for 12 hours.

Freeze-Thaw Soak Test

The samples were immersed in water for 24 hours then subjected to −19° C. for 24 hours. This was repeated for 3 cycles. The samples were then dried at 100° C. for 12 hours.

Small Scale Intermediate Calorimetry Testing

A 3000 W rectangle panel with a heating electric wire as Fe—Ni alloy, was used as a radiation source, with a size of 18 cm×28 cm. The samples were then brought within 10 cm of the radiant panel and the back temperature of the OSB was measured by a thermocouple. Temperature rise as a function of time is shown below in Table 5. As can be seen from the data, the weatherability testing meant to mimic outdoor exposure has no effect on the performance of the laminate.

TABLE 5
Weatherability data

| | Control | UV-water | Freeze Thaw |
|---|---|---|---|
| Time (s) | (° C.) | (° C.) | (° C.) |
| 120 | 34.3 | 31.6 | 31.3 |
| 300 | 84.3 | 75.8 | 70.6 |
| 600 | 102.3 | 108.2 | 101.5 |
| 900 | 172.6 | 159.4 | 144.6 |

In addition to the thermocouple data, the quality of the char structure was evaluated by two qualitative measurements. The first is an evaluation of the char during the test and for all samples, the integrity of the char was not compromised as there were large sections of char falling off the specimen during the test. The second test was as follows: after the test was completed, the specimen was shaken at 1-2 Hz. In all the samples, this induced motion did not cause the char to deteriorate and fall from the specimen.

TABLE 6
Char integrity

| Char strength | Control | UV-water | Freeze Thaw |
|---|---|---|---|
| Char falling during test | No | No | No |
| Char falling during shaking | No | No | No |

1. A fire retardant laminate, comprising an inorganic fiber; and a fire retardant coating applied on the inorganic fiber, wherein the fire retardant coating comprises an aromatic isocyanate component, a polyol component and an intumescent component.

2. The fire retardant laminate of claim 1, wherein the aromatic isocyanate component is present in a quantity ranging from about 10% to about 30% by weight of the coating.

3. The fire retardant laminate of claim 1, wherein the polyol component is present in a quantity ranging from about 20% to about 60% by weight of the coating.

4. The fire retardant laminate, of claim 1, wherein the intumescent component is present in a quantity ranging from about 1% to about 40% by weight of the total coating.

5. The fire retardant laminate of claim 1, wherein the polyol component is selected from the group consisting of naturally derived polyol, polyether polyol, polyester polyol, or a combination thereof.

6. The fire retardant laminate of claim 1, wherein the polyol component is a naturally derived polyol selected from the group consisting of castor oil, hydroxylated soybean oil, or a combination thereof.

7. The fire retardant laminate of claim 1, wherein the polyol component is an aromatic polyol selected from the group consisting of aromatic polyether polyol, aromatic polyester polyol, or a combination thereof.

8. The fire retardant laminate of claim 1, wherein the polyol component is selected from the group consisting of castor oil, aromatic polyol, or a combination thereof.

9. The fire retardant laminate of claim 1, wherein the inorganic fiber is a glass fiber or ceramic fiber.

10. The fire retardant laminate of claim 1, wherein the inorganic fiber is a clay coated glass fiber mat, a glass fiber mat attached to an aluminum foil, or a clay coated glass fiber mat attached to an aluminum foil

11. The fire retardant laminate of claim 1, wherein the coating further comprises one or more additive components, wherein the sum of the polyol, intumescent component, aromatic isocyanate, and additive components does not exceed 100%.

12. The fire retardant laminate of claim 11, wherein the additive components are selected from the group consisting of surfactants, wetting agents, opacifying agents, colorants, viscosifying agents, catalysts, preservatives, fillers, leveling agents, defoaming agents, diluents, hydrated compounds, halogenated compounds, acids, bases, salts, borates, melamine, halogenated flame retardant, moisture scavenger, and organophosphorus flame retardants.

13. The fire retardant laminate of claim 1, wherein it exhibits a good weatherability and retain fire performance after both 3 cycles of freeze thaw soak and 7 cycles of uv spray testing.

14. A fire-resistant wood product comprising:
a wood element having one or more surfaces; and
a fire retardant laminate of claim 1 applied to at least a portion of the one or more surfaces.

15. A fire-resistant building product comprising:
A cellulose-based, gypsum, (bio)polymeric, or cementitious element having one or more surfaces; and a fire retardant laminate of claim 1 applied to at least a portion of the one or more surfaces.
